(19) United States
(12) Patent Application Publication
(10) Pub. No.: US 2026/0253599 A1
(43) Pub. Date: Aug. 27, 2026

(54) BALANCED SPEECH RECONSTRUCTION AND NOISE SUPPRESSION USING DUAL-ASYMMETRIC LOSS

(71) Applicant: SKYWORKS SOLUTIONS, INC., Irvine, CA (US)

(72) Inventor: Merlin Phillip CARSON, Portland, OR (US)

(21) Appl. No.: 19/535,565

(22) Filed: Feb. 10, 2026

Related U.S. Application Data
(60) Provisional application No. 63/756,428, filed on Feb. 10, 2025.

(51) Int. Cl. G10L 21/0264

(52) U.S. Cl. CPC G10L 21/0264

(57) ABSTRACT

An audio processor can include a circuit configured to provide a digital signal representative of a sound, and a digital signal processor configured to process the digital signal. The digital signal processor can be configured to process an enhancement model and including a loss function having a first penalty term selected to control sound reconstruction, and a second penalty term selected to control noise suppression. The first and second penalty terms can be weighted by an adjustable parameter to allow the enhancement model to be tuned for quality of sound or performance of noise suppression.

### CROSS-REFERENCE TO RELATED APPLICATION(S)

This application claims priority to U.S. Provisional Application No. 63/756,428 filed Feb. 10, 2025, entitled BALANCED SPEECH RECONSTRUCTION AND NOISE SUPPRESSION USING DUAL-ASYMMETRIC LOSS, the disclosure of which is hereby expressly incorporated by reference herein in its entirety.

### BACKGROUND

### Field

The present disclosure relates to audio processors configured for speech reconstruction and noise suppression.

### Description of the Related Art

Speech enhancement algorithms are becoming increasingly prevalent in speech transmission applications and devices. These algorithms typically utilize neural networks to predict a filter or mask that is applied to a speech signal to reduce noise. However, such a process can degrade speech quality due to often-overlapping frequency responses of the speech and noise components. High-performance noise suppression can attenuate frequencies where the two signals overlap, resulting in muffled or processed sounding speech.

### SUMMARY

In accordance with a number of implementations, the present disclosure relates to an audio processor that includes a circuit configured to provide a digital signal representative of a sound, and a digital signal processor configured to process the digital signal. The digital signal processor is configured to process an enhancement model and includes a loss function having a first penalty term selected to control sound reconstruction, and a second penalty term selected to control noise suppression. The first and second penalty terms are weighted by an adjustable parameter to allow the enhancement model to be tuned for quality of sound or performance of noise suppression.

In some embodiments, the loss function can include a dual-asymmetric loss function. The dual-asymmetric loss function can be selected to provide a linear combination of the first and second penalty terms based on the adjustable parameter.

In some embodiments, the enhancement model can include a speech enhancement functionality, and the sound reconstruction can include speech reconstruction.

In some implementations, the present disclosure relates to a method for processing audio signal. The method includes providing a digital signal representative of a sound, and processing the digital signal. The processing includes operating an enhancement model with a loss function having a first penalty term selected to control sound reconstruction, and a second penalty term selected to control noise suppression. The first and second penalty terms are weighted by an adjustable parameter to allow the enhancement model to be tuned for quality of sound or performance of noise suppression.

In some embodiments, the enhancement model can include a speech enhancement functionality, and the sound reconstruction can include speech reconstruction.

In some implementations, the present disclosure relates to a non-transitory computer readable medium that, when executed, performs functions including providing a digital signal representative of a sound, and processing the digital signal. The processing includes operating an enhancement model with a loss function having a first penalty term selected to control sound reconstruction, and a second penalty term selected to control noise suppression. The first and second penalty terms are weighted by an adjustable parameter to allow the enhancement model to be tuned for quality of sound or performance of noise suppression.

In some implementations, the present disclosure relates to an electronic chip that includes a substrate and an audio processor implemented on the substrate. The audio processor includes a circuit configured to provide a digital signal representative of a sound, and a digital signal processor configured to process the digital signal. The digital signal processor is configured to process an enhancement model and including a loss function having a first penalty term selected to control sound reconstruction, and a second penalty term selected to control noise suppression. The first and second penalty terms are weighted by an adjustable parameter to allow the enhancement model to be tuned for quality of sound or performance of noise suppression.

In some implementations, the present disclosure relates to an electronic device that includes a functional circuit and an audio processor configured to operate with the functional circuit. The audio processor includes a circuit configured to provide a digital signal representative of a sound, and a digital signal processor configured to process the digital signal. The digital signal processor is configured to process an enhancement model and includes a loss function having a first penalty term selected to control sound reconstruction, and a second penalty term selected to control noise suppression. The first and second penalty terms are weighted by an adjustable parameter to allow the enhancement model to be tuned for quality of sound or performance of noise suppression.

In some embodiments, the electronic device can be an audio device configured to generate sound based on the processed digital signal. In some embodiments, the audio device can be, for example, a headset, an earbud or a sound bar.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows an audio processor having one or more features as described herein, where such an audio processor can be configured to provide a desired balance between speech reconstruction and noise suppression using dual-asymmetric loss technique.

FIG. 2 shows results of evaluation on a deep noise suppression (DNS) Blind testset.

FIG. 3 shows Valintini results of the DNS Blind testset.

FIG. 4 shows DNSMOS scores for various models evaluated on the DNS Blind testset.

FIG. 5 shows that in some embodiments, an audio processor having one or more features as described herein can be implemented on a chip.

FIG. 6 shows that in some embodiments, an audio processor having one or more features as described herein can be included in an electronic device.

FIG. 7 shows that in some embodiments, the electronic device of FIG. 6 can be a wireless device.

FIG. 8 shows that in some embodiments, the electronic device of FIG. 6 can be an audio device.

### DETAILED DESCRIPTION OF SOME EMBODIMENTS

The headings provided herein, if any, are for convenience only and do not necessarily affect the scope or meaning of the claimed invention.

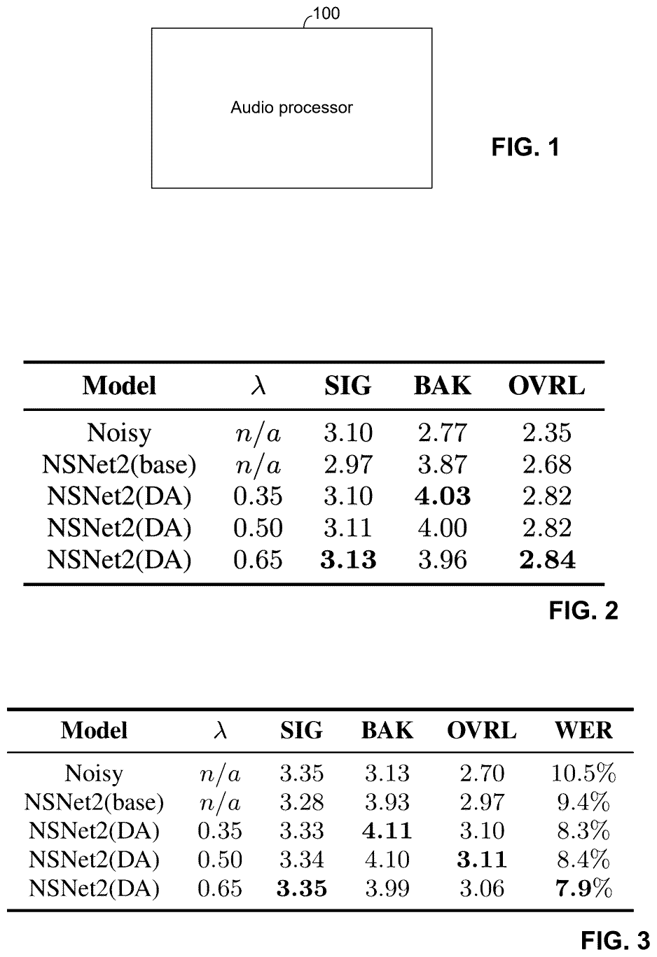

FIG. 1 shows an audio processor 100 having one or more features as described herein. In some embodiments, such an audio processor can be configured to provide a desired balance between speech reconstruction and noise suppression using dual-asymmetric loss technique. Various examples related to such a technique are described herein in greater detail.

AI-based speech enhancement algorithms are becoming increasingly prevalent in speech transmission applications and devices. These algorithms typically utilize neural networks to predict a filter or mask that is applied to a speech signal to reduce noise. However, this process can degrade speech quality due to often-overlapping frequency responses of the speech and noise components. High-performance noise suppression can attenuate frequencies where the two signals overlap, resulting in muffled or processed sounding speech.

Some consumer electronics mix the processed signal with the original noisy signal to restore some of the naturalness to the speech, but this approach introduces significant noise leakage.

Described herein are examples related to a novel loss function that has an adjustable parameter that balances the importance of reconstructing the original speech and the effectiveness of noise suppression.

Consumer electronics industry has made significant progress in addressing background distractions in speech transmissions now that AI-based speech enhancement (SE) and noise suppression is available on mobile phones, headsets, true wireless earbuds and nearly all remote conferencing platforms. SE is even a built-in feature on many computer operating systems (OS) or available as software plugins through a paid subscription. However, performance of these algorithms varies greatly based on, for example, publisher, platform, and even audio hardware used as input.

Research has shown that memory-intensive, high-computation SE can perform extremely well at reducing nearly all background noise and transparently reproducing speech given a certain minimum signal-to-noise ratio (SNR). However, deployment platforms such as headsets and earbuds are both memory and computationally constrained devices and therefore cannot utilize these high-computation SE algorithms. Even mobile phones or OS-based solutions, which are not as memory constrained and have significantly more processing power, still must constrain the amount of computation and memory usage to allow for the multiprocessing nature of these systems to be able to seamless run other computationally and memory intensive algorithms such as graphics or video heavy applications.

Common approaches to address model scale is to reduce the number of parameters or use less complex neural network operations (e.g., S. Braun, H. Gamper, C. K. A. Reddy, and I. J. Tashev, “Towards efficient models for real-time deep noise suppression,” ICASSP 2021-2021 IEEE International Conference on Acoustics, Speech and Signal Processing (ICASSP), pp. 656-660, 2021; https://api.semanticscholar.org/CorpusID: 231693296), but with no other notable changes to training strategy. However, consequences of these optimizations can negatively affect speech quality and noise suppression in an undefined way. This could result in a model that still performs well at reducing noise but produces poor quality speech, or produces decent speech quality but does not reduce much noise, not necessarily a well-balanced decrease in overall performance.

This undefined behavior does not allow for tuning SE performance for task-specific purposes. For example, in competitive gaming, high-performance noise suppression might be more desirable than high-quality speech, since a user likely prefers to stay focused and not have any non-game noise distractions. Conversely, in a search and rescue scenario or emergency call, some amount of noise leakage could be acceptable, but it is of importance that speech is not harmed, since attenuating parts of words or frequencies can change the meaning of what is transmitted, which could have negative consequences.

Among others, to address a need to balance the importance of speech reconstruction and noise suppression, the present disclosure includes a novel objective function for training SE models, dual-asymmetric loss. In some implementations, this function includes an adjustable parameter that controls a linear combination of penalties that separately optimize for noise suppression and speech reconstruction.

Some research has been done regarding weighted speech and noise components in an objective function (e.g., Y. Xia, S. Braun, C. K. A. Reddy, H. Dubey, R. Cutler, and I. Tashev, “Weighted speech distortion losses for neural-network-based real-time speech enhancement,” in ICASSP 2020-2020 IEEE International Conference on Acoustics, Speech and Signal Processing (ICASSP), 2020, pp. 871-875). However, these penalties do not include a specific speech reconstruction term or noise suppression term, but instead offer a weighted combination of the standard mean squared error (MSE) on frames with speech and the residual noise on frames without speech. This provides no specific penalty for the attenuation of speech or a weight on the overall importance of noise suppression. The dual-asymmetric loss can include two unique terms, one that penalizes attenuated speech and another which targets noise only features.

Described herein are examples related to motivation and mathematical components of a dual-asymmetric loss. Then, model parameters and training procedures that can be used to test the loss function are discussed. Then, examples of experimental results are discussed for a range of parametric values to validate the usefulness of the loss for balancing the importance of speech reconstruction and noise suppression when training SE models.

For familiarity purposes, and to demonstrate that the proposed loss works well on simple architectures and therefore should extend well to memory-intensive, high-computation SE algorithms, the SE model chosen as an example is the NSNet2 model (e.g., S. Braun and I. Tashev, “Data augmentation and loss normalization for deep noise suppression,” 2020). It is noted that Microsoft provides a pretrained version of this model as a baseline for past deep noise suppression (DNS) challenges (e.g., H. Dubey, V. Gopal, R. Cutler, A. Aazami, S. Matusevych, S. Braun, S. E. Eskimez, M. Thakker, T. Yoshioka, H. Gamper, and R. Aichner, “Icassp 2022 deep noise suppression challenge,” in ICASSP, 2022). This model includes an encoder, a latent space, and a decoder. The encoder includes a single fully connected layer with 400 neurons. The time-dependent latent space includes two gated recurrent unit (GRU) layers with 400 neurons per layer. Finally, the decoder includes three fully connected layers, two with 600 neurons and a final with 255 neurons, matching the size of the input and output feature space. All fully connected layers have ReLU activations except the final layer, which utilizes a Sigmoid activation to produce values in the range of [0, 1] that are used to generate an ideal ratio mask (IRM). In total the model contains six neural network layers and is made up of approximately 2.8 million parameters.

The foregoing model is trained using ICASSP 2021 DNS Challenge (e.g., C. K. A. Reddy, H. Dubey, V. Gopal, R. Cutler, S. Braun, H. Gamper, R. Aichner, and S. Srinivasan, “Icassp 2021 deep noise suppression challenge,” in ICASSP, 2021) speech and noise training data. The baseline NSNet2 uses log power as input features to the neural network, which is lower-bounded to prevent undefined values. However, for this example, power compressed magnitudes (e.g., Y. Ju, W. Rao, X. Yan, Y. Fu, S. Lv, L. Cheng, Y. Wang, L. Xie, and S. Shang, “Tea-pse: Tencent-ethereal-audiolab personalized speech enhancement system for icassp 2022 dns challenge,” ICASSP 2022-2022 IEEE International Conference on Acoustics, Speech and Signal Processing (ICASSP), pp. 9291-9295, 2022; https://api.semanticscholar.org/CorpusID: 249437259) are used, which produce positive semidefinite values; a compression value of 0.3 is used in this example. The first FFT bin, the DC component, and the last FFT bin, the Nyquist, are removed from the input and output since they do not contain valuable information about the speech and noise content of the signal. The model is trained for 600 epochs using the AdamW optimizer (e.g., I. Loshchilov and F. Hutter, “Decoupled weight decay regularization,” in International Conference on Learning Representations, 2017; https://api.semanticscholar.org/CorpusID: 53592270) with a constant weight decay of 0.01. The warmup learning rate is chosen to be 10-4 and is linearly ramped up over 3 epochs to 10-3, after which a cosine annealing learning rate scheduler is used to reduce the learning rate to 10-6 over the remaining epochs (e.g., H. Schröter, A. N. Escalante, T. Rosenkranz, and A. K. Maier, “Deepfilternet2: Towards real-time speech enhancement on embedded devices for full-band audio,” 2022 International Workshop on Acoustic Signal Enhancement (IWAENC), pp 1-5, 2022; https://api.semanticscholar.org/CorpusID: 248693185).

It is noted that dual-asymmetric loss as described herein can involve two objective functions found in SE literature. The first primary component can be derived from a complex compressed mean squared error (e.g., S. Braun, H. Gamper, C. K. A. Reddy, and I. J. Tashev, “Towards efficient models for real-time deep noise suppression,” ICASSP 2021-2021 IEEE International Conference on Acoustics, Speech and Signal Processing (ICASSP), pp. 656-660, 2021; https://api.semanticscholar.org/CorpusID: 231693296). This loss contains both a complex term shown in Equation 1 and a magnitude term shown in Equation 2. Despite the model producing an IRM and using a noisy phase to reconstruct the signal, applying a small penalty to the complex components when training with STFT consistency improves model performance, as applying a mask to overlapping frames does not guarantee a consistent STFT (e.g., S. Wisdom, J. R. Hershey, K. Wilson, J. Thorpe, M. Chinen, B. Patton, and R. A. Saurous, “Differentiable consistency constraints for improved deep speech enhancement,” in ICASSP 2019-2019 IEEE International Conference on Acoustics, Speech and Signal Processing (ICASSP), 2019, pp. 900-904). The complete loss can be seen in Equation 3 with a scaling factor α to weigh the importance of the two terms.

$${ℒ}_{cplx} = {\sum }_{k , n} {\vert {\vert S \vert}^{c} {e}^{j ∠ S} - {\vert \hat{S} \vert}^{c} {e}^{j ∠ \hat{S}} \vert}^{2} \qquad ( 1 )$$

$${ℒ}_{mag} = {\sum }_{k , n} {\vert {\vert S \vert}^{c} - {\vert \hat{S} \vert}^{c} \vert}^{2} ) \qquad ( 2 )$$

$$ℒ = {αℒ}_{cplx} + ( 1 - α ) {ℒ}_{mag} \qquad ( 3 )$$

Referring to Equations 1-3, it is noted that the compression factor c reduces the magnitude of the loss between loud and quite parts of the signal and is assigned a value 0.3. The weighting factor between the magnitude and complex components of the loss, a, is also assigned a value of 0.3, which assigns a greater importance to correctly matching the predicted magnitudes with the ground truth than to the complex components. Both parameter values are commonly found in SE literature and were experimentally validated.

The second primary component can be derived from the asymmetric loss (e.g., Y. Ju, S. Zhang, W. Rao, Y. Wang, T. Yu, L. Xie, and S. Shang, “Tea-pse 2.0: Sub-band network for real-time personalized speech enhancement,” 2022 IEEE Spoken Language Technology Workshop (SLT), pp. 472-479, 2023; https://api.semanticscholar.org/CorpusID: 256345171). This loss, seen in Equation 4, is an MSE on the magnitudes, but the difference between the ground truth and the predicted signal is lower bounded to zero using a ReLU activation function.

$${ℒ}_{asym} = {\sum }_{k , n} {\vert Re LU ( {\vert S \vert}^{c} - {\vert \hat{S} \vert}^{c} ) \vert}^{2} ) \qquad ( 4 )$$

A motivation of this loss can include addition of an extra penalty to the model when it over-suppresses time-frequency bins that contain speech. If there is more noise energy in the predicted signal than in the ground truth, the difference is negative, but with the ReLU operation, this becomes zero or no penalty. However, if there is less speech energy in the predicted signal than in the ground truth, the difference is positive, indicating some attenuation of speech and, therefore, resulting in a penalty.

It is noted that for the dual-asymmetric loss, the asymmetry feature is not only applied to penalize speech attenuation, as seen in Equation 4, but also swaps the terms of the difference prior to the ReLU function to produce a penalty specific to where residual noise exists in the reconstructed signal. This produces an asymmetric term for a speech-only penalty and an asymmetric term for a noise-only penalty. The former enforces that the model does not attenuate speech, while the latter pushes the model to suppress all noise.

These can be, however, contradictory terms. For the speech term to approach zero, the model could simply produce a mask of all ones, attenuating none of the original speech. The noise term can approach zero by predicting a mask of all zeros, attenuating all the signal and thus all the noise. For these terms to work in harmony, an adjustable parameter λ can be introduced to balance speech reconstruction and noise suppression. Low values of λ encourage the model to perform well on noise suppression at the cost of some amount of speech signal attenuation. Conversely, high values of λ force the model to maintain a near perfect reconstruction of speech from the original signal at the cost of some noise leakage, especially where it overlaps with speech. When the value of λ is 0.5, the function is equally balanced and reduces to be equivalent to a scaled-down version of the complex compressed mean squared error seen in Equation 3.

Each term, asymmetric speech of Equation 5 and asymmetric noise of Equation 7, includes a complex and magnitude component. Since attenuation cannot be determined by a sign difference in the complex plane such as can be done with the magnitudes, an indicator function for attenuated speech (as) of Equation 6 and residual noise (rn) of Equation 8 can be defined using the difference of magnitudes for both symmetries. This indicator function can be applied to the corresponding complex components of each of the asymmetric terms to include only the bin errors that apply to the term.

$$\begin{matrix}{ℒ}_{speech} = α {\sum }_{k , n} {\vert {\text{?}}_{as} ( {\vert S \vert}^{c} {e}^{j ∠ S} - {\vert \hat{S} \vert}^{c} {e}^{j ∠ \hat{S}} ) \vert}^{2} + ( 1 - α ) {\sum }_{k , n} {\vert Re LU ( {\vert S \vert}^{c} - {\vert \hat{S} \vert}^{c} ) \vert}^{2} \\ where ,\end{matrix} \qquad ( 5 )$$

$${\text{?}}_{as} = \{ \begin{matrix}1 & if Re LU ( {\vert S \vert}^{c} - {\vert \hat{S} \vert}^{c} ) > 0 \\ 0 & if Re LU ( {\vert S \vert}^{c} - {\vert \hat{S} \vert}^{c} ) = 0\end{matrix} \qquad ( 6 )$$

$$\begin{matrix}{ℒ}_{noise} = α {\sum }_{k , n} {\vert {\text{?}}_{rn} ( {\vert \hat{S} \vert}^{c} {e}^{j ∠ \hat{S}} - {\vert S \vert}^{c} {e}^{j ∠ S} ) \vert}^{2} + ( 1 - α ) {\sum }_{k , n} {\vert Re LU ( {\vert \hat{S} \vert}^{c} - {\vert S \vert}^{c} ) \vert}^{2} \\ where ,\end{matrix} \qquad ( 7 )$$

$${\text{?}}_{rn} = \{ \begin{matrix}1 & if Re LU ( {\vert \hat{S} \vert}^{c} - {\vert S \vert}^{c} ) > 0 \\ 0 & if Re LU ( {\vert \hat{S} \vert}^{c} - {\vert S \vert}^{c} ) = 0\end{matrix} \qquad ( 8 )$$

Combining the two terms, L_{speech} and Lₙₒᵢₛₑ, with weighting parameter A, forms the dual-asymmetric loss expression in Equation 9.

$$ℒ ( S , \hat{S} ) = λ {L}_{speech} + ( 1 - λ ) {L}_{noise} . \qquad ( 9 )$$

To test the foregoing dual-asymmetric loss, 13 NSNet2 models were trained with λ values [0.2, 0.8] in 0.05 increments. Perceptual evaluation of speech quality (PESQ) (e.g., A. W. Rix, J. G. Beerends, M. P. Hollier, and A. P. Hekstra, “Perceptual evaluation of speech quality (pesq)-a new method for speech quality assessment of telephone networks and codecs,” in 2001 IEEE International Conference on Acoustics, Speech, and Signal Processing. Proceedings (Cat. No. 01CH37221), vol. 2, 2001, pp. 749-752 vol. 2), an outdated ITU standard for evaluating speech communication systems, is generally an accepted metric used in literature for measuring SE performance. However, recent work has shown that SE models can be optimized specifically for this metric, achieving unbelievably high scores despite producing speech distortions and artifacts (e.g., D. de Oliveira, S. Welker, J. Richter, and T. Gerkmann, “The pesqetarian: On the relevance of goodhart's law for speech enhancement,” in Interspeech 2024, 09 2024, pp. 3854-3858). PESQ also only produces a single overall score, which is not significantly useful in differentiating between good speech quality and noise suppression performance. Therefore, for this work, the models were evaluated using DNSMOS (e.g., C. K. A. Reddy, V. Gopal, and R. Cutler, “Dnsmos p.835: A nonintrusive perceptual objective speech quality metric to evaluate noise suppressors,” in ICASSP, 2022) and word error rate (WER).

DNSMOS is an AI-model developed at Microsoft to evaluate SE systems by approximating the ITU-T Rec. P.835 standard for subjective evaluation of speech communication systems. DNSMOS produces three mean opinion scores, SIG, the quality of the speech signal, BAK, the intrusiveness of the noise, and OVRL, the overall quality of the audio. For all metrics, higher scores are better. Additionally, for datasets with transcriptions, word error rate (WER) is also used for evaluation, as it is important that SE performance does not negatively impact commonly used ASR tools or significantly alter the message of the transmitted speech. To calculate WER, Whisper, a general-purpose speech recognition model developed by OpenAI (e.g., A. Radford, J. W. Kim, T. Xu, G. Brockman, C. McLeavey, and I. Sutskever, “Robust speech recognition via large-scale weak supervision,” in Proceedings of the 40th International Conference on Machine Learning, ser. ICML′23. JMLR.org, 2023), can be used to collect transcriptions on the processed audio to compare against the ground truth.

The DNSMOS scores can be calculated across two dataset for each of the 13 models, the baseline NSNet2, and the original noisy signals. The first dataset tested on is the ICASSP 2021 DNS Challenge Track 1 Blind Testset. This is a crowd-sourced set of 700 noisy audio files recorded in real environments with real noises, ranging in length from 2 to 26 seconds. The second dataset tested on is the Valintini noisy testset. This is synthetically created data including real speech selected from CSTR VCTK Corpus and noise from the Demand database. There are a total of 824 audio clips ranging from 1 to 10 seconds, mixed at various SNR levels. Since this testset was originally developed to train and test SE and text-to-speech models, it includes human annotated transcriptions of the speech and, therefore, is used to determine WER for all the listed conditions.

Results of the evaluation on the DNS Blind testset are summarized in the table shown in FIG. 2, and the Valintini results are summarized in the table shown in FIG. 3. In addition to noisy, unprocessed data and the baseline, models trained with 3 different λ values are shown for brevity. The results of the model trained with a λ of 0.35 show performance when the loss is weighted towards optimizing more for noise suppression than perfect speech reconstruction, and the effectiveness is shown by having the highest BAK score of the groups. The model trained with λ equal to 0.5 shows how the loss performs when the two terms are evenly balanced, and thus results in a good balance of SIG and BAK, and achieves the highest OVRL on the Valintini dataset. Finally, the model trained with a λ or 0.65 shows the results of weighting the loss more towards optimizing for transparent speech reconstruction than noise suppression, resulting in the highest SIG score of the groups. It can also be seen that all models trained using the dual-asymmetric loss performed better with regard to WER on the Valintini testset compared to the baseline, with the model tuned for the highest speech quality achieving the lowest error.

Referring to FIG. 2, the table shows comparison of results between the baseline NSNet2 and the dual-asymmetric loss experiments using the DNS Blind testset. The model denoted “(base)” refers to the baseline NSNet2 model from the DNS Challenge, while the models denoted “(DA)” refer to models trained with the dual-asymmetric loss. The model trained with a λ of 0.35 achieved the highest BAK score since this lower value favors optimizing for noise suppression over speech reconstruction. The model trained with a λ of 0.5 achieved a good balance of speech quality and noise suppression, as this value evenly balances optimization for both. The model trained with an λ of 0.65 achieved the highest SIG score since this higher value favors optimizing for speech reconstruction over noise suppression.

Referring to FIG. 3, the table shows comparison of results between the baseline NSNet2 and the dual-asymmetric loss experiments using the Valentini dataset. The model denoted “(base)” refers to the baseline NSNet2 model from the DNS Challenge, while the models denoted “(DA)” refer to models trained with the dual-asymmetric loss. The model trained with a λ of 0.35 achieved the highest BAK score since this lower value favors optimizing for noise suppression over speech reconstruction. The model trained with a λ of 0.5 achieved the highest OVRL score since this value evenly balances optimization for both speech reconstruction and noise suppression. The model trained with a λ of 0.65 achieved the highest SIG score since this higher value favors optimizing for speech reconstruction over noise suppression. The WER can also be seen for all conditions, showing that the model optimized for higher speech quality achieved the lowest error.

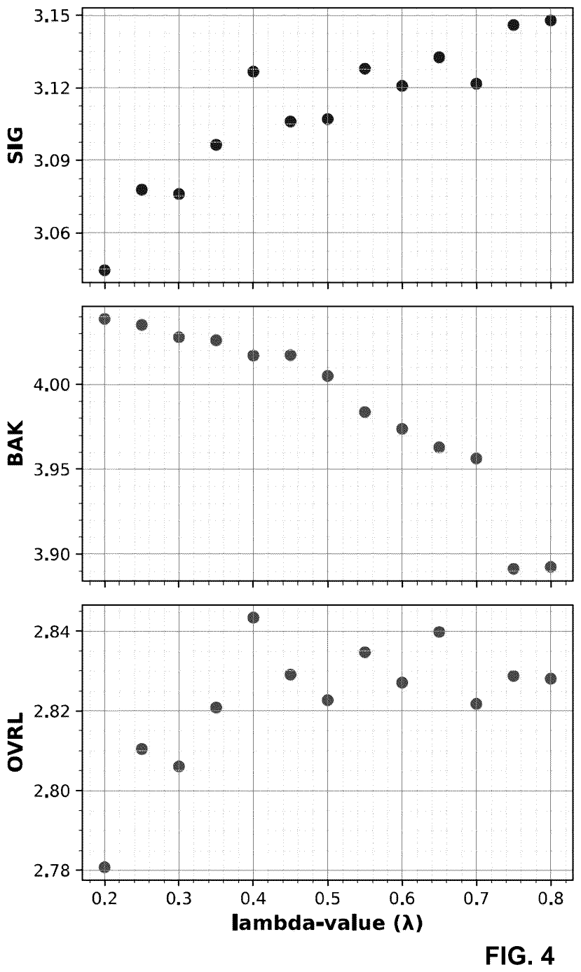

To show that the balancing of speech reconstruction and noise suppression holds true across a wide range of λ, FIG. 4 shows the DNSMOS scores for all 13 models evaluated on the DNS Blind testset. In FIG. 4, the three scatter plots show the DNSMOS evaluation results on the DNS Blind Testset for all 13 experiments with λ values [0.2, 0.8] in increments of 0.05. The top plot displays the SIG scores, showing a high positive correlation between λ and SIG. The middle plot displays the BAK scores, showing a high inverse correlation between λ and BAK. The bottom plot displays the OVRL scores, showing that the highest scores generally appear near mid A values where there is a greater balance of speech quality and noise suppression.

It can be seen that as the λ value increases, weighting the loss more towards speech reconstruction, the SIG quality starts low and generally has a positive trajectory. The Pearson correlation coefficient (PCC) between λ and SIG for these experiments is 0.90 with a p-value of 2.6×10⁻⁵, signifying a high correlation between the variables that is statistically significant. The BAK score, however, starts high where the loss is weighted more towards noise suppression, and generally has a negative trajectory as the value of λ increases. The PCC between λ and BAK for these experiments is 0.94 with a p-value of 2.5×10⁻⁶, signifying a high negative or inverse correlation between the variables that is also statistically significant. Finally, it can be seen that the OVRL score starts low where speech quality is low and noise suppression is high, plateaus at a λ value of 0.4, where both the BAK and SIG scores are relatively high, resulting in the best overall combination of speech quality and noise suppression.

Referring to FIG. 4, it is noted that outliers for all three metrics show the limits of the loss function. At a λ of 0.2 there is a notable drop off in the SIG score, since at this value the model is much more weighted towards noise suppression, producing audio that has very little or no noise at the cost of attenuating much of the high-end frequencies of speech. This problematic behavior can also be seen in the OVRL score at this value. In contrast, with λ at 0.75 and above, there is a significant drop in BAK score. However, at these values the SIG quality is at its highest, so despite only achieving a low level of noise suppression, the overall quality is still relatively good, as is observed by the OVRL metric. The highest OVRL scores can be seen at λs 0.4 and 0.65, the former performing better noise suppression but with good quality speech reconstruction, while the latter performing better quality speech reconstruction but with good noise suppression performance. Depending on the specific deployment target or task, λ values slightly offset from the center seem to be preferable to maintain a good balance of performance between noise suppression and speech quality while still targeting a preference between the two.

As described herein, effects of a loss function can include separate penalty terms that specifically target speech reconstruction and noise suppression. An adjustable parameter can be introduced to weight these terms, allowing a model to be tuned for higher-quality speech or higher-performance noise suppression. A range of these values were experimentally tested to verify that the loss function achieves the desired results. Using updated training techniques adopted from more recent SE research, the example NSNet2 models trained with the dual-asymmetric loss outperformed the baseline NSNet2 model on all DNSMOS metrics for the evaluated datasets and achieved a lower WER.

In some implementations, VAD labeling can be added to the loss function to, for example, calculate the penalty on the speech segments with higher λ values and non-speech sections with lower λ values. Such a technique can enable models to reconstruct nearly transparent speech while providing highly performant noise suppression when speech is not present. Such an approach can be configured to gate nearly all noise during extended periods of non-speech without any significant negative effect at a sudden onset of speech.

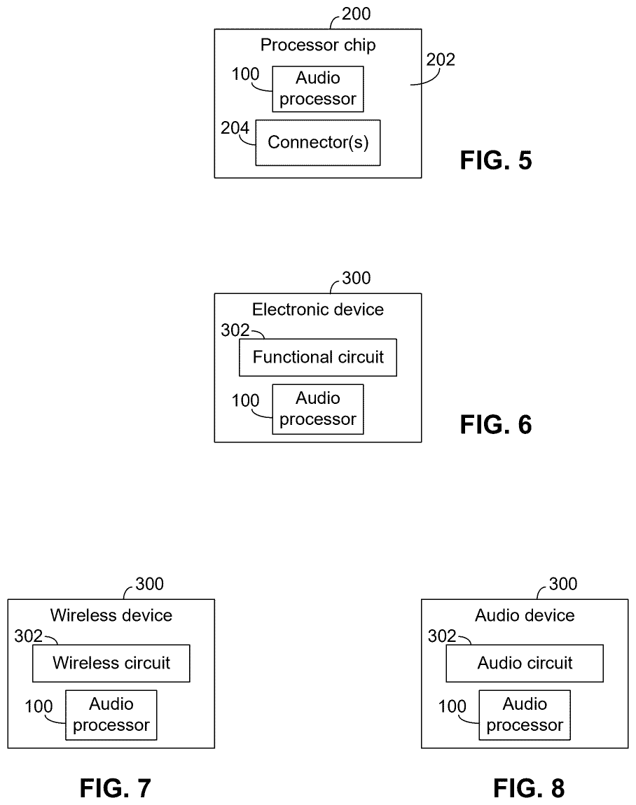

FIG. 5 shows that in some embodiments, an audio processor 100 having one or more features as described herein can be implemented on a chip 200. In some embodiments, such a chip can be a semiconductor die, a packaged module, or some combination thereof.

For example, if the chip 200 is implemented as a semiconductor die, such a die can include a semiconductor substrate 202, and some or all of the audio processor 100 can be implemented on the substrate 202.

In another example, if the chip 200 is implemented as a packaged module, such a module can include a packaging substrate 202, and some or all of the audio processor 100 can be implemented on one or more die that is/are mounted on the packaging substrate 202.

In the example of FIG. 5, the chip 200 is also shown to include connector(s) 204 configured to provide connections for the audio processor 100.

FIG. 6 shows that in some embodiments, an audio processor 100 having one or more features as described herein can be included in an electronic device 300. Such an electronic device is shown to also include a functional circuit 302 that utilizes one or more functionalities provided by the audio processor 100.

In the example of FIG. 6, in some embodiments, the processor 100 can be implemented in the chip form as described in reference to FIG. 5.

FIG. 7 shows that in some embodiments, the electronic device of FIG. 6 can be a wireless device 300. Such a wireless device can include an audio processor 100 having one or more features as described herein. Such an electronic device is shown to also include a functional circuit such as a wireless circuit 302 that utilizes one or more functionalities provided by the audio processor 100.

FIG. 8 shows that in some embodiments, the electronic device of FIG. 6 can be an audio device 300. Such an audio device can be a wireless device, wired device, or some combination thereof, and can include, for example, a headset, an earbud, and a soundbar. In some embodiments, such an audio device can include an audio processor 100 having one or more features as described herein, and also include a functional circuit such as an audio circuit 302 that utilizes one or more functionalities provided by the audio processor 100.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. An audio processor comprising:
a circuit configured to provide a digital signal representative of a sound; and
a digital signal processor configured to process the digital signal, the digital signal processor configured to process an enhancement model and including a loss function having a first penalty term selected to control sound reconstruction, and a second penalty term selected to control noise suppression, the first and second penalty terms weighted by an adjustable parameter to allow the enhancement model to be tuned for quality of sound or performance of noise suppression.

2. The audio processor of claim 1 wherein the loss function includes a dual-asymmetric loss function.

3. The audio processor of claim 2 wherein the dual-asymmetric loss function is selected to provide a linear combination of the first and second penalty terms based on the adjustable parameter.

4. The audio processor of claim 1 wherein the enhancement model includes a speech enhancement functionality, and the sound reconstruction includes speech reconstruction.

5. A method for processing audio signal, the method comprising:
providing a digital signal representative of a sound; and
processing the digital signal, the processing including operating an enhancement model with a loss function having a first penalty term selected to control sound reconstruction, and a second penalty term selected to control noise suppression, the first and second penalty terms weighted by an adjustable parameter to allow the enhancement model to be tuned for quality of sound or performance of noise suppression.

6. The method of claim 5 wherein the enhancement model includes a speech enhancement functionality, and the sound reconstruction includes speech reconstruction.

7. (canceled)

8. (canceled)

9. An electronic device comprising:
a functional circuit; and
an audio processor configured to operate with the functional circuit, the audio processor including a circuit configured to provide a digital signal representative of a sound, and a digital signal processor configured to process the digital signal, the digital signal processor configured to process an enhancement model and including a loss function having a first penalty term selected to control sound reconstruction, and a second penalty term selected to control noise suppression, the first and second penalty terms weighted by an adjustable parameter to allow the enhancement model to be tuned for quality of sound or performance of noise suppression.

10. The electronic device of claim 9 wherein the electronic device is an audio device configured to generate sound based on the processed digital signal.

11. The electronic device of claim 10 wherein the audio device is a headset, an earbud or a sound bar.

12. The method of claim 5 wherein the loss function includes a dual-asymmetric loss function.

13. The method of claim 12 wherein the dual-asymmetric loss function is selected to provide a linear combination of the first and second penalty terms based on the adjustable parameter.

14. The method of claim 5 wherein the enhancement model includes a speech enhancement functionality, and the sound reconstruction includes speech reconstruction.

15. The electronic device of claim 9 wherein the loss function includes a dual-asymmetric loss function.

16. The electronic device of claim 16 wherein the dual-asymmetric loss function is selected to provide a linear combination of the first and second penalty terms based on the adjustable parameter.

17. The electronic device of claim 9 wherein the enhancement model includes a speech enhancement functionality, and the sound reconstruction includes speech reconstruction.
